(19) United States
(12) Patent Application Publication
(10) Pub. No.: US 2022/0300158 A1
(43) Pub. Date: Sep. 22, 2022

(54) STORAGE APPARATUS AND STORAGE APPARATUS CONTROL METHOD

(71) Applicant: Hitachi, Ltd., Tokyo (JP)

(72) Inventors: Hiroki KUSHIDA, Tokyo (JP); Yuki KOTAKE, Tokyo (JP); Takafumi MARUYAMA, Tokyo (JP); Akihiro SHIKANO, Tokyo (JP)

(73) Assignee: Hitachi, Ltd., Tokyo (JP)

(21) Appl. No.: 17/475,862

(22) Filed: Sep. 15, 2021

(30) Foreign Application Priority Data
Mar. 19, 2021 (JP) 2021-045558

(51) Int. Cl. G06F 3/06

(52) U.S. Cl. CPC G06F 3/0604; G06F 3/0625; G06F 3/0653; G06F 3/0683

(57) ABSTRACT

A storage apparatus comprises: a plurality of storage devices that read and write data by operating in any one of a plurality of operation modes which vary in electric power consumption; and a control unit that controls the storage devices, wherein each of the plurality of storage devices retains power state information indicating electric power consumption of each of the operation modes; and wherein the control unit acquires the power state information from each of the plurality of storage devices and sets the operation modes for the plurality of storage devices on the basis of the acquired power state information and permissible electric power consumption which can be assigned to each of the storage devices.

### INCORPORATION BY REFERENCE

The disclosure of the following priority application is herein incorporated by reference: Japanese Patent Application No. 2021-45558 filed on Mar. 19, 2021.

### BACKGROUND OF THE INVENTION

### Field of the Invention

The present invention relates to a storage apparatus and control method thereof.

### Description of Related Art

PTL 1 (Japanese Laid-Open Patent Publication No. 2019-125111) is known as a document that discloses background art of the present invention. PTL 1 describes, regarding an information processing apparatus coupled to a storage device to control the storage device, a technology that: acquires first information indicating a correspondence relationship between maximum electric power consumption and electric power consumption efficiency at each link rate in a first electric power throttling mode which prioritizes performance, and a correspondence relationship between maximum electric power consumption and electric power consumption efficiency at each link rate in a second electric power throttling mode which prioritizes reduction of peak electric power; and decides the electric power throttling mode which is suited for a mode designated by a user from among a first mode prioritizing the performance, a second mode prioritizing reduction of electric power consumption, and a third mode prioritizing suppression of the peak electric power, on the basis of the mode designated by the user and the acquired first information. For example, if the first mode which prioritizes the performance is selected by the user, the first electric power throttling mode is set to the storage device so that the storage device can exhibit the maximum performance. Accordingly, it is designed so that the electric power consumption of the storage device can be controlled flexibly.

In recent years, the use of storage apparatuses capable of operating as controlled by external information processing apparatuses and reading/writing a large amount of data has been expanding along with, for example, the spread of cloud computing. The above-described storage apparatus is generally equipped with many storage devices configured by using HDDs (Hard Disk Drives), SSDs (Solid State Drives) or the like in order to reserve a storage capacity and enhance throughput, and a power supply circuit for supplying electric power to these storage devices.

Regarding the control of each storage device in the storage apparatus, it is necessary to prevent the entire electric power consumption of the storage devices from exceeding the power supply ability of the power supply circuit. However, with the technology of PTL 1, no consideration is paid to the electric power supply ability of the power supply circuit. Accordingly, if the technology of PTL 1 is applied to a storage apparatus, the entire electric power consumption of the storage devices may exceed the electric power supply ability of the power supply circuit depending on a mode designated by a user and, therefore, a failure or an abnormal operation may be caused.

Moreover, the storage apparatus may be sometimes equipped with a mixed combination of storage devices of different manufacturers or storage devices of the same manufacturer, but with different specifications. In this case, a set value of the electric power consumption may possibly vary depending on each storage device, so that it is necessary to control each storage device in consideration of the above. However, the technology of PTL 1 cannot perform the control in consideration of differences between the respective storage devices in the set value of the electric power consumption.

Furthermore, the configuration of the storage apparatus may sometimes change because of, for example, addition or replacement of storage devices. However, the technology of PTL 1 cannot perform appropriate control for the above-described change in the configuration of the storage devices.

The conventional technology has the problem as explained above that it is difficult to perform appropriate electric power control for the storage apparatus. So, it is an object of the present invention to realize the appropriate electric power control for the storage apparatus.

### SUMMARY OF THE INVENTION

A storage apparatus according to the present invention comprises: a plurality of storage devices that read and write data by operating in any one of a plurality of operation modes which vary in electric power consumption; and a control unit that controls the storage devices, wherein each of the plurality of storage devices retains power state information indicating electric power consumption of each of the operation modes; and wherein the control unit acquires the power state information from each of the plurality of storage devices and sets the operation modes for the plurality of storage devices on the basis of the acquired power state information and permissible electric power consumption which can be assigned to each of the storage devices.

A storage apparatus control method according to the present invention, which is a method for controlling a storage apparatus equipped with a plurality of storage devices that read and write data by operating in any one of a plurality of operation modes which vary in electric power consumption, comprises: acquiring power state information indicating electric power consumption of each of the operation modes from each of the plurality of storage devices; and setting the operation modes for the plurality of storage devices on the basis of the acquired power state information and permissible electric power consumption which can be assigned to each of the storage devices.

Appropriate electric power control for the storage apparatus can be realized according to the present invention.

### BRIEF DESCRIPTION OF DRAWINGS

FIG. 1 is a block diagram illustrating the configuration of a storage apparatus according to an embodiment of the present invention;

FIG. 2 is an operation explanatory diagram when activating SSDs;

FIG. 3 is an operation explanatory diagram after the activation of the SSDs;

FIG. 4 is an operation explanatory diagram after the activation of the SSDs;

FIG. 5A is a table showing a setting example of the number of simultaneous activation devices of the SSDs;

FIG. 5B is a table showing an example of activation status of each SSD;

FIG. 6A is a table showing an example of power state information;

FIG. 6B is a table showing an example of parameter information included in the power state information;

FIG. 7A is a table showing a search result example of the power state number for each SSD;

FIG. 7B is a table showing an example of the electric power consumption and the power state setting for each SSD;

FIG. 8 is an operation sequence diagram upon the electric power control of a storage apparatus according to an embodiment of the present invention;

FIG. 9 is a flowchart illustrating a processing flow upon the electric power control of a storage apparatus according to an embodiment of the present invention;

FIG. 10 is a flowchart of SSD activation processing;

FIG. 11 is a flowchart of power state application processing; and

FIG. 12 is a flowchart of power state monitoring processing.

### DESCRIPTION OF PREFERRED EMBODIMENTS

Embodiments of the present invention will be explained with reference to the drawings. Some omission and simplification are employed in the following description and the drawings as appropriate in order to clarify the explanation. The present invention is not limited to these embodiments and any and all application examples which comply with the idea of the present invention are included in the technical scope of the present invention. Unless particularly limited, each constituent element may be either plural or singular.

In the following explanation, for example, the expression “xxx table” will be sometimes used to explain various kinds of information; however, the various kinds of information may be expressed by using data structures other than the table. The expression “xxx information” may be sometimes used instead of “xxx table” in order to indicate that the various kinds of information does not depend on the data structures.

Furthermore, a “controller” may be configured of one or more computers in the following explanation.

An embodiment of the present invention will be explained below.

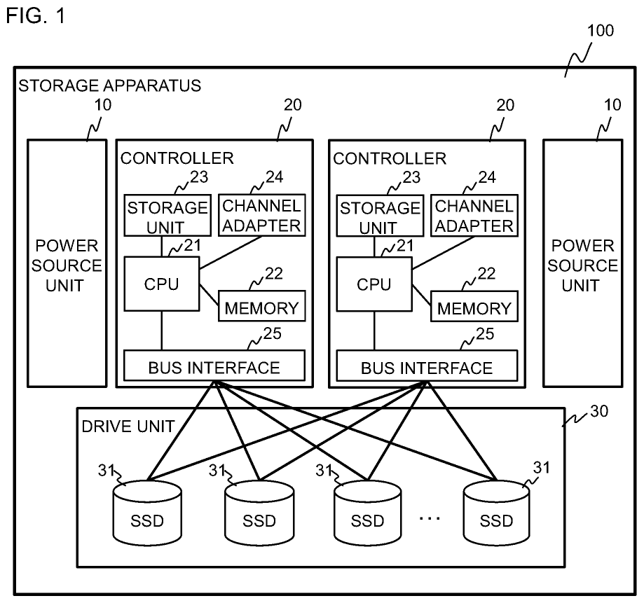

FIG. 1 is a block diagram illustrating the configuration of a storage apparatus according to an embodiment of the present invention. A storage apparatus 100 is configured by including power source units 10, controllers 20, and a drive unit 30. Incidentally, FIG. 1 illustrates an example of the storage apparatus 100 in which two power source units 10 and two controllers 20 are provided, thereby constituting a redundant system; however, there may be one power source unit 10 and one controller 20 which are included in the storage apparatus 100. Moreover, three or more power source units 10 and three or more controllers 20 may be provided and the number of the power source units 10 may be different from the number of the controllers 20.

The drive unit 30 includes a plurality of SSDs 31 which are storage devices. Each SSD 31 is controlled by the controller 20 and reads/writes data. Incidentally, FIG. 1 illustrates an example where the drive unit 30 includes a plurality of SSDs 31 as storage devices; however, for example, HDDs or the like may be used instead of the SSDs. Furthermore, the number of the SSDs 31 included in the drive unit 30 may be determined arbitrarily and the number of the SSDs 31 can be increased/decreased or the SSD(s) 31 can be replaced during the operation of the storage apparatus 100.

The power source unit 10 supplies electric power which is required for operations of the controller 20 and the drive unit 30. The power source unit 10 generates, for example, direct-current power with commercial power supply as input and supplies it to the controller 20 and the drive unit 30. Incidentally, the power source unit 10 has specified power supply ability and cannot supply the electric power in excess of the power supply ability. Therefore, the storage apparatus 100 needs to control them so that the electric power consumption of the controller 20 and the drive unit 30 does not exceed the power supply ability of the power source unit 10.

The controller 20 controls the drive unit 30 and includes a CPU (Central Processing Unit) 21, a memory 22, a storage unit 23, a channel adapter 24, and a bus interface 25.

The CPU 21 controls the drive unit 30 and the entire storage apparatus 100 by executing programs stored in the storage unit 23 by using the memory 22 as a work area. The memory 22 is configured by using, for example, a DRAM (Dynamic Random Access Memory) and stores various kinds of data to be used by the program which is being executed by the CPU 21. The storage unit 23 is a nonvolatile storage device storing an OS (Operating System) and various programs which are required for operations of the CPU 2; and is configured by using, for example, a flash memory.

The channel adapter 24 is coupled to a host system, which is not illustrated in the drawing, via a network and executes interface processing of various kinds of data which are input and output between the storage apparatus 100 and the host system. The bus interface 25 is coupled to each SSD 31 of the drive unit 30 and executes interface processing of various kinds of data which are input and output between the CPU 21 and each SSD 31.

When the host system transmits a data write request or a data read request via the channel adapter 24, the CPU 21 outputs various kinds of control commands and data according to such request to each SSD 31 via the bus interface 25. Consequently, the controller 20 controls the drive unit 30, thereby enabling reading/writing of data in response to a request from the host system.

Next, the electric power control of the SSDs 31 which is performed by the storage apparatus 100 will be explained. When activating each SSD 31 possessed by the drive unit 30 or when starting the operation after completing the activation of each SSD 31, the storage apparatus 100 according to this embodiment causes the controller 20 to perform the electric power control of each SSD 31 so that the electric power consumption of the entire storage apparatus 100 will not exceed the power supply ability of the power source unit 10. The details of this electric power control of the SSDs 31 will be explained below.

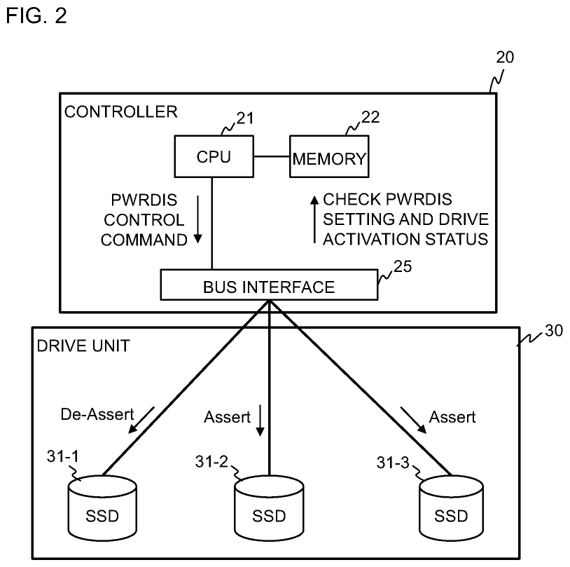

FIG. 2 is an operation explanatory diagram when activating SSDs. Incidentally, FIG. 2 illustrates only one controller 20 in order to make the explanation easily understandable and the illustration of the storage unit 23 and the channel adapter 24, which are not directly involved in the electric power control of the SSDs 31, are omitted in this controller 20. Furthermore, the drive unit 30 includes three SSDs 31 and these three SSDs 31 are indicated as an SSD 31-1, an SSD 31-2, and an SSD 31-3. However, the number of the SSDs 31 which can be included in the drive unit 30 is not limited to three. Even if the number of SSDs is other than three, similar processing is possible.

When the electric power is supplied to the storage apparatus 100, the CPU 21 in the controller 20 activates each SSD of the drive unit 30. When this happens, the CPU 21 decides an activation target SSD(s) so that the number of SSDs to be activated simultaneously in the drive unit 30 becomes equal to or less than the number of simultaneous activation devices which is previously determined according to the electric power consumption of each SSD and the power supply ability of the power source unit 10. As a result, for example, if the SSD 31-1 is decided as the activation target, the CPU 21 issues a PWRDIS control command to activate only the SSD 31-1 and not activate the SSDs 31-2, 31-3. The PWRDIS control command is a control command to designates, to each SSD possessed by the drive unit 30, whether the power supply to the power source unit 10 should be enabled or disabled. This control command is determined according to a communication protocol such as the NVMe (Non-Volatile Memory Express).

Once the PWRDIS control command is issued from the CPU 21, the bus interface 25 checks a PWRDIS set value and activation status of each SSD in the drive unit 30 by checking data stored in the memory 22. Then, based on these check results, as illustrated in FIG. 2, the bus interface 25 outputs a control signal to set “De-Assert” as the PWRDIS set value to the SSD 31-1 and a control signal to set “Assert” as the PWRDIS set value to the SSDs 31-2, 31-3, respectively. Incidentally, “De-Assert” is the PWRDIS set value to start supplying the electric power from the power source unit 10 to the relevant SSD and activate the relevant SSD; and “Assert” is the PWRDIS set value to keep the power supply from the power source unit 10 to the relevant SSD in a stopped state. As the control signals according to these PWRDIS set values are input to a specified signal pin provided in each SSD, each SSD performs the operation according to the PWRDIS set value.

When the control signal to designate the PWRDIS set value for “De-Assert” is input from the bus interface 25, the SSD 31-1 starts activation processing according to this control signal. When this happens, the electric power required for the activation processing is supplied from the power source unit 10 to the SSD 31-1. On the other hand, if the control signal to designate the PWRDIS set value for “Assert” is input from the bus interface 25, the SSDs 31-2, 31-3 maintain the operation stop state. When this happens, the electric power is not supplied from the power source unit 10 to the SSDs 31-2, 31-3.

When the activation of the SSD 31-1 terminates, the CPU 21 decides an SSD to be the next activation target. As a result, for example, if the SSD 31-2 is decided as the activation target, the CPU 21 issues a PWRDIS control command to activate the SSD 31-2 and not activate the SSD 31-3, while maintaining the operation of the activated SSD 31-1. The bus interface 25 outputs a control signal according to this PWRDIS control command to each of the SSDs 31-2, 31-3.

The CPU 21 repeats the above-explained processing until all the SSDs are activated in the drive unit 30. Accordingly, the respective SSDs of the drive unit 30 are sequentially activated in the quantity equal to or less than the number of simultaneous activation devices. Therefore, as compared to the case where all the SSDs are activated simultaneously, it is possible to suppress the electric power consumption when activating the drive unit 30 and prevent the power source unit 10 from exceeding its power supply ability.

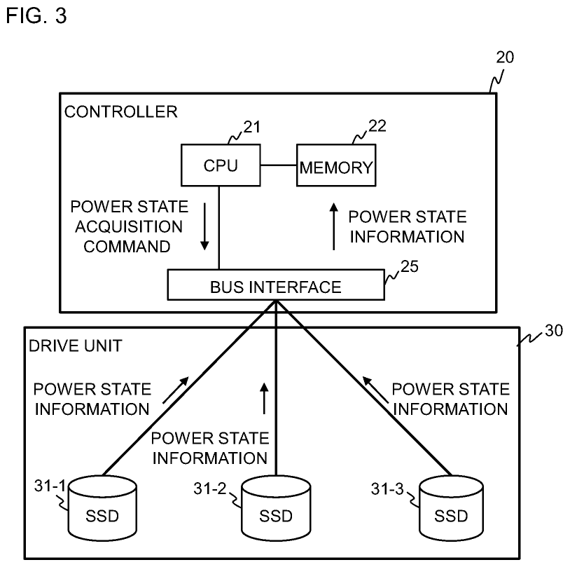

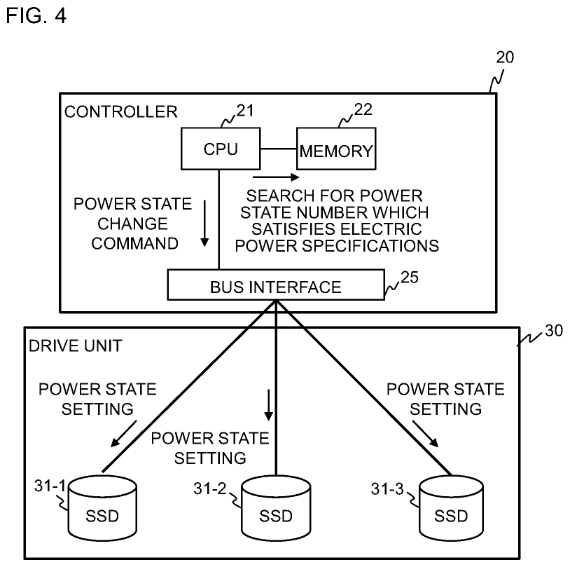

FIG. 3 and FIG. 4 are operation explanatory diagrams after the activation of the SSDs. Incidentally, in FIG. 3 and FIG. 4 as in the same manner as in FIG. 2, the illustration of the storage unit 23 and the channel adapter 24 which are not directly involved in the electric power control of the SSDs 31 in the controller 20 is omitted. Furthermore, the drive unit 30 includes three SSDs 31 and these three SSDs 31 are indicated as the SSD 31-1, the SSD 31-2, the SSD 31-3, respectively.

When the activation of each SSD in the drive unit 30 is completed, the CPU 21 in the controller 20 issues a power state acquisition command to each SSD to request power state information. The power state acquisition command is a control command to issue an instruction to each SSD possessed by the drive unit 30 to transmit the power state information retained by each SSD. The power state information is information indicating the electric power consumption of the relevant SSD in each predetermined operation mode. Specifically speaking, the SSDs can generally operate in any one of a plurality of operation modes and the electric power consumption varies depending on each operation mode. For example, the electric power consumption in an operation mode in which data is read/written at a maximum bit rate is relatively large, while the electric power consumption in an operation mode at a bit rate lower than the above-mentioned maximum bit rate is relatively small. Therefore, it is designed so that the controller 20 adjusts the electric power consumption of the entire drive unit 30 by designating the operation mode to each SSD when controlling the drive unit 30. The power state information is the information used for this control and is defined according to the communication protocol such as the NVMe (Non-Volatile Memory Express).

The power state acquisition command issued from the CPU 21 is output via the bus interface 25 to each of the SSDs 31-1, 31-2, 31-3. Each SSD which has received the power state acquisition command transmits the power state information which it retains, to the controller 20 as illustrated in FIG. 3. The bus interface 25 acquires the power state information transmitted from each of the SSDs 31-1, 31-2, 31-3 and stores it in the memory 22.

The CPU 21 searches for the power state number which satisfies specified electric power specifications with respect to each of the SSDs 31-1, 31-2, 31-3 on the basis of the power state information stored in the memory 22 as illustrated in FIG. 4. Under this circumstance, different numbers are previously set to the plurality of respective operation modes, in which the electric power consumption varies as described earlier, to the SSDs 31-1, 31-2, 31-3. This number is called a power state number (PS number) and is used by the CPU 21 to adjust the electric power consumption by designating the operation mode of each SSD. In other words, as the CPU 21 designates the power state number, the operation mode is thereby controlled and each of the SSDs 31-1, 31-2, 31-3 consumes the electric power according to the operation mode.

With the storage apparatus 100 according to this embodiment, the electric power specifications of each SSD are previously set according to the permissible electric power consumption which can be assigned to each SSD by the power source unit 10. The CPU 21 sets the operation mode of each SSD so that the electric power consumption of each SSD becomes within the range of the electric power specifications.

However, the relationship between the power state number and the electric power consumption with respect to each SSD is not necessarily the same. There is a case where even if the power state numbers are the same, the electric power consumption may vary depending on each SSD according to differences in the manufacturers or the specifications of the SSDs. So, the storage apparatus 100 according to this embodiment is designed so that by searching for the power state number which satisfies the electric power specifications with respect to each SSD, such differences in settings between the operation mode and the electric power consumption with respect to each SSD can be absorbed and the drive unit 30 can operate normally. Incidentally, the details of a method for searching for the power state number which satisfies the electric power specifications will be explained later.

When the power state number which satisfies the electric power specifications has been successfully found by the search with respect to each SSD, the CPU 21 issues a power state change command to each SSD to designate that power state number. The power state change command is a control command to designate, to each SSD possessed by the drive unit 30, the operation mode of each SSD by using the power state number and is defined according to the communication protocol such as the NVMe (Non-Volatile Memory Express).

When the power state change command is issued from the CPU 21, the bus interface 25 performs the power state setting to each SSD by informing each SSD of the designated power state number. Accordingly, the operation modes of the SSD 31-1, the SSD 31-2, and the SSD 31-3 in the drive unit 30 are decided respectively and the operation of these SSDs is started. Therefore, even if the correspondence relationship between the power state number and the electric power consumption in each operation mode varies depending on each SSD, the operation mode of each SSD can be set appropriately according to the power supply ability of the power source unit 10 and the electric power consumption during the operation can be prevented from exceeding the power supply ability of the power source unit 10.

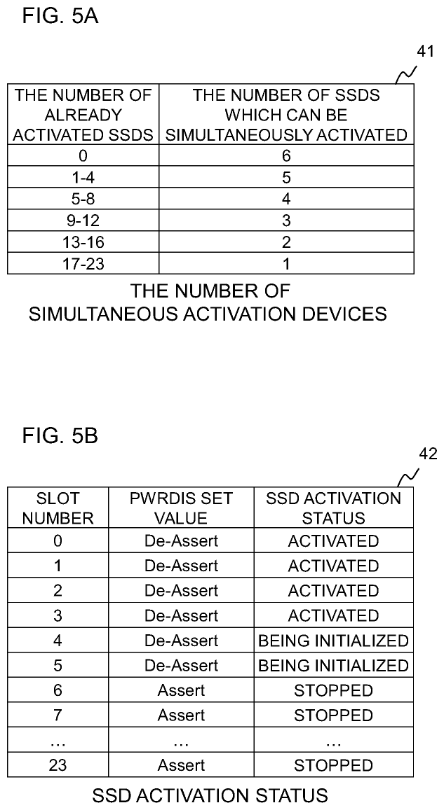

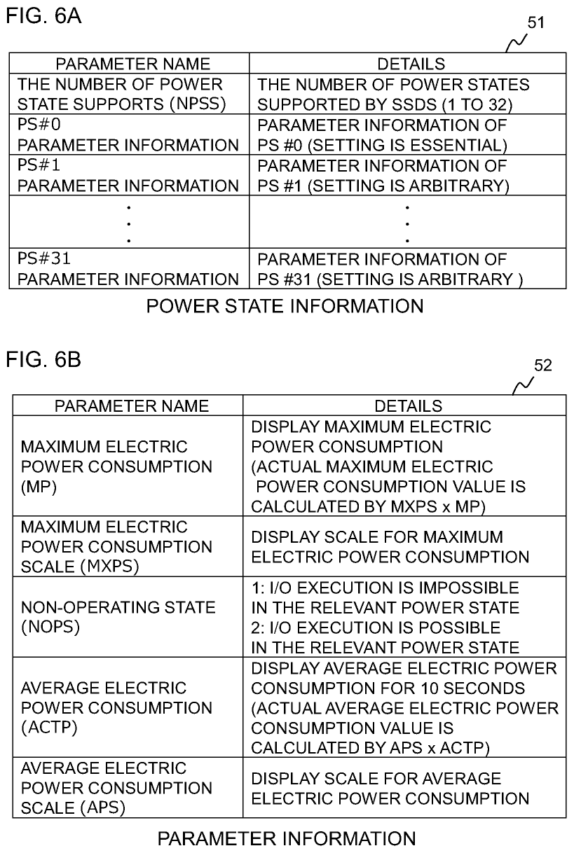

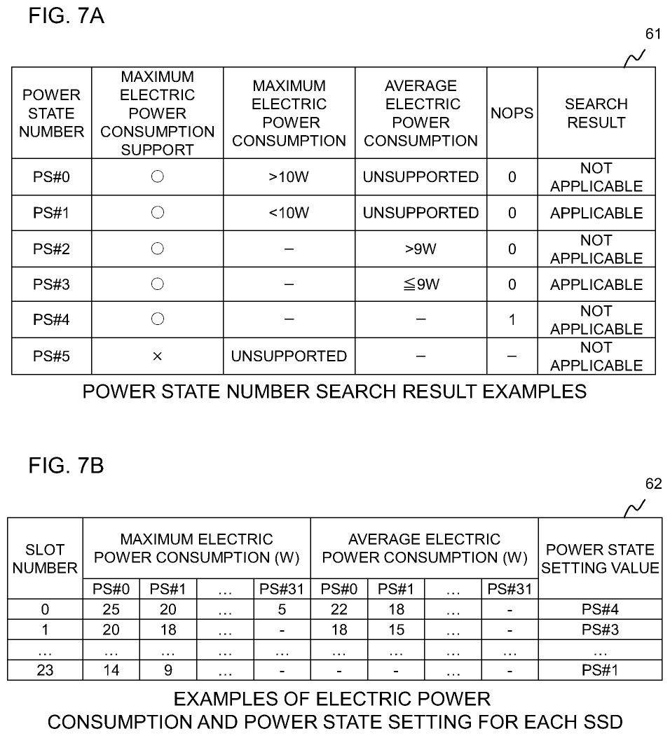

Next, specific examples of the electric power control of the SSDs 31, which is performed in the storage apparatus 100, will be explained with reference to FIG. 5, FIG. 6, and FIG. 7.

FIG. 5A is a table illustrating a setting example of the number of simultaneous activation devices of SSDs for the drive unit 30. The number of simultaneous activation devices when the respective SSDs of the drive unit 30 are sequentially activated in the controller 20 is set in a relationship as indicated in, for example, a table 41 illustrated in FIG. 5A with respect to each number of already activated SSDs and this setting information is stored in the storage unit 23 in advance. In other words, the above-described relationship is determined so that the larger the number of the already activated SSDs in the drive unit 30 becomes, the smaller the number of simultaneous activation devices becomes. Accordingly, when a large number of SSDs are sequentially activated, it is possible to limit and prevent the electric power consumption of the entire storage apparatus 100 including the drive unit 30 from exceeding the power supply ability of the power source unit 10 and minimize the activation time until the completion of the activation of all the SSDs.

FIG. 5B is a table illustrating an example of the activation status of each SSD after the power application to the storage apparatus 100. It is assumed with the storage apparatus 100, for example, as illustrated in a table 42 that the drive unit 30 has 24 SSDs 31 and slot numbers 0 to 23 are assigned to the SSDs, respectively. Furthermore, let us assume that after the power is supplied to the storage apparatus 100, for example, the PWRDIS set value of each SSD of the slot numbers 0 to 3 is set as “De-Assert” and these SSDs have been activated; and the PWRDIS set value of each SSD of the slot numbers 4 and 5 is set as “De-Assert” and these SSDs are being initialized. In such a case, the electric power consumption of the SSD 31 which is being initialized increases more than that of the already activated SSD. Therefore, the controller 20 checks the activation status of each of the SSDs with the slot numbers 4 and 5; and after the completion of the initialization of these SSDs, the controller 20 sets “De-Assert” as the PWRDIS set value of SSDs with the slot numbers 6 and higher.

FIG. 6A is a table illustrating an example of the power state information retained by each SSD. The power state information is configured by including, for example, as indicated in a table 51, the number of supports for the power state of the relevant SSD, that is, the number of power state supports (NPSS: Number of the Power State Supports) indicating the number of operation modes which can be designated for the relevant SSD, and parameter information for each power state number corresponding to each operation mode. Incidentally, the parameter information is set to each power state number (PS #0 to PS #31) which is designated between 1 to 32 for the number of power state supports, and at least the parameter information of PS #0 among these pieces of parameter information is an essential setting element for the power state information.

FIG. 6B is a table illustrating an example of the parameter information included in the power state information. The parameter information is configured by including, for example, information of each parameter value as illustrated in a table 52.

Maximum electric power consumption (MP: Maximum Power) and maximum electric power consumption scale (MXPS: Max Power Scale) indicate the maximum electric power consumption of the SSDs in the operation mode corresponding to the relevant power state number and the scale for such maximum electric power consumption, respectively. Incidentally, an actual value of the maximum electric power consumption of the relevant SSD is calculated by a multiplication of the above values.

A non-operational state (NOPS: Non-Operational State) indicates whether the operation mode of the SSD corresponding to the relevant power state number is in the non-operational state or not. If this parameter value is “1,” this indicates that it is in the non-operational state, that is, it is in the operation mode where the I/O processing cannot be executed; and if the parameter value is “0,” this indicates that it is in an operational state, that is, the I/O processing can be executed.

Average electric power consumption (ACTP: Active Power) and average electric power consumption scale (APS: Active Power Scale) indicate the average electric power consumption of the SDD in the operation mode corresponding to the relevant power state number, and the scale for such average electric power consumption, respectively. Incidentally, an actual value of the average electric power consumption of the relevant SSD is calculated by a multiplication of the above values.

FIG. 7A is a table illustrating search result examples of the power state number for each SSD. The controller 20 searches for the power state number which satisfies the electric power specifications of each SSD as described earlier on the basis of the power state information acquired from each SSD. As a result, for example, the search result as illustrated in a table 61 is obtained with respect to a certain SSD 31. The table 61 shows that, in the respective power state numbers of PS #0 to PS #5 supported for the relevant SSD, PS #1 regarding which the maximum electric power consumption is less than 10 W, and PS #3 regarding which the average electric power consumption is equal to or less than 9 W have been found by the search as the power state numbers which are applicable for the relevant SSD.

Incidentally, the table 61 in FIG. 7A shows the search result examples of the power state numbers when the condition requiring that the maximum electric power consumption which can be assigned to each SSD (permissible maximum electric power consumption) is less than 10 W, and the condition requiring that the average electric power consumption which can be assigned to each SSD (permissible average electric power consumption) is equal to or less than 9 W, are set to the storage apparatus 100. In other words, it is shown that the power state number which satisfies either one of these conditions has been found by the search as the power state number which is applicable for the relevant SSD.

FIG. 7B is a table illustrating setting examples of the electric power consumption and the power state for each SSD in the drive unit 30. For example, when the drive unit 30 has 24 SSDs 31 and the slot numbers 0 to 23 are assigned to them, respectively, each SSD acquires the power state setting value according to its electric power consumption as illustrated in a table 62. The table 62 also shows the maximum electric power consumption and the average electric power consumption with respect to each power state number of each SSD 31; and the smaller the power state number of the operation mode is, the higher the above-mentioned values are set. The controller 20 sets the power state of each SSD based on the acquired power state setting value and stores the power state setting value in the memory 22.

Incidentally, as the information of the power state setting value of each SSD as illustrated in the table 62 is stored in the storage unit 23, this information may be read from the storage unit 23 and the power state of each SSD may be set when the electric power is supplied to the storage apparatus 100 again. By doing so, it becomes possible to set the power state according to the electric power specifications with respect to each SSD without searching for the power state number every time the electric power is supplied to the storage apparatus 100 again.

Subsequently, the details of the electric power control of the SSDs 31 performed in the storage apparatus 100 will be explained.

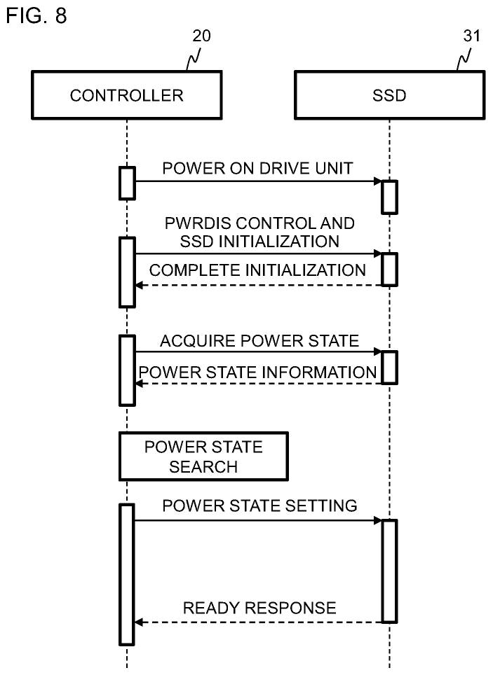

FIG. 8 is a diagram illustrating an operation sequence upon the electric power control of the storage apparatus according to an embodiment of the present invention.

When the electric power is supplied to the storage apparatus 100, the controller 20 turns on the power of the drive unit 30. Then, the controller 20 outputs the PWRDIS control command to each SSD 31 of the drive unit 30 as explained with reference to FIG. 2 and sequentially activates and initializes each of the SSDs 31 in the quantity equal to or less than the number of simultaneous activation devices. After the completion of the initialization, each SSD 31 notifies the controller 20 of the completion of the initialization.

After receiving the initialization completion notice from the SSD 31, the controller 20 outputs the power state acquisition command to the relevant SSD as explained with reference to FIG. 3. The SSD 31 which has received this command transmits the power state information, which itself retains, to the controller 20.

After receiving the power state information from each SSD 31, the controller 20 searches for the power state number which satisfies the electric power specifications as explained earlier with referenced to FIG. 4. Then, the controller 20 sets the power state to each SSD 31 by using the power state number found by the search. After the completion of setting of the power state, each SSD 31 returns a ready reply to the controller 20 and proceeds to a standby state. After all the SSDs 31 have proceeded to the standby state, the controller 20 determines that the activation of the drive unit 30 has been completed, and starts operating the drive unit 30.

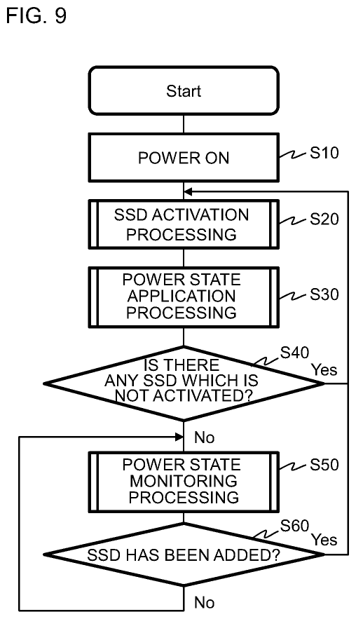

FIG. 9 is a flowchart illustrating a flow of processing upon the electric power control of the storage apparatus according to an embodiment of the present invention. The CPU 21 of the controller 20 starts executing this processing when the electric power is supplied to the storage apparatus 100 and this processing is executed continuously regularly during the operation of the storage apparatus 100.

In step S10, the CPU 21 turns on the power of the drive unit 30.

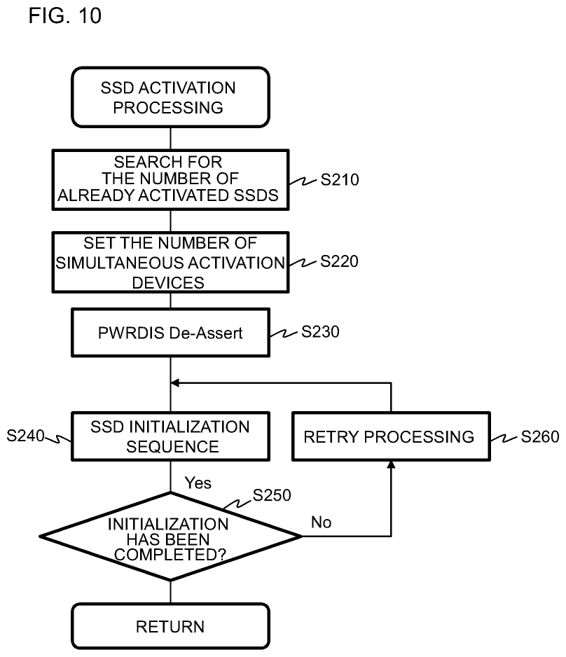

In step S20, the CPU 21 executes SSD activation processing on each of the SSDs 31 which have not been activated yet in the drive unit 30, for sequentially activating these SSDs 31 in the quantity equal to or less than the number of simultaneous activation devices. The details of this SSD activation processing will be explained later with reference to FIG. 10.

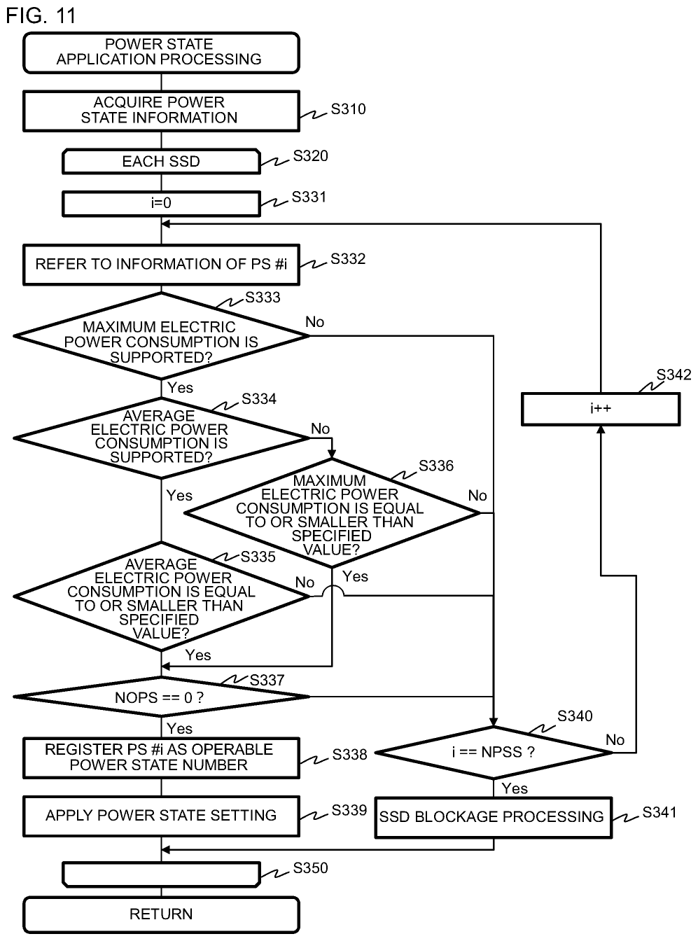

In step S30, the CPU 21 executes power state application processing for setting the operation mode according to specified electric power specifications to each SSD 31 activated in step S20. The details of this power state application processing will be explained later with reference to FIG. 11.

In step S40, the CPU 21 judges whether or any SSD 31 which has not been activated yet exists in the drive unit 30. This judgment in step S40 is performed by, for example, judging whether any ready reply from each SSD 31 to the CPU 21 exists or not. As a result, if it is determined that the SSD 31 which has not been activated exists, the processing returns to step S20 and the CPU 21 continuously executes the SSD activation processing in step S20 and the power state application processing in step S30. On the other hand, if it is determined that all the SSDs 21 possessed by the drive unit 30 have been activated, the CPU 21 starts operating the drive unit 30 and proceeds to the next step S50.

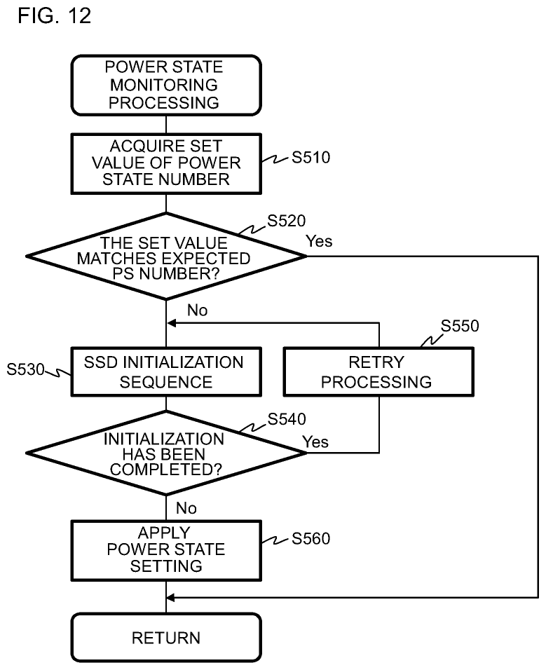

In step S50, the CPU 21 executes power state monitoring processing for regularly monitoring whether or not the operation mode is appropriate for each SSD 31 operating in the drive unit 30. With the storage apparatus 100, an operation mode which is different from an operation mode that was set at the time of activation may be sometimes mistakenly set due to some reasons such as abnormal operation of the SSD(s) 31 and any operation mistake by an administrator who manages the storage apparatus 100. So, the storage apparatus 100 according to this embodiment: checks whether a correct operation mode is set to each SSD 31 or not by regularly executing the power state monitoring processing in step 50 during the operation; and resets the operation mode if a wrong operation mode is set. Accordingly, it is designed to prevent the electric power consumption of the entire storage apparatus 100 from exceeding the power supply ability of the power source unit 10 due to an erroneous setting of the operation mode of the SSD 31. Incidentally, the details of the power state monitoring processing executed in step S50 will be explained later with reference to FIG. 12.

In step S60, the CPU 21 judges whether or not an SSD 31 is added to the drive unit 30. If the SSD 31 is added, the CPU 21 returns to step S20 to activate the relevant SSD and cause it to start its operation. Then, the CPU 21 incorporates the relevant SSD as an operation target in the drive unit 30 by executing the SSD activation processing in step S20 and the power state application processing in step S30 with respect to the relevant SSD. On the other hand, if no SSD 31 is added to the drive unit 30, the CPU 21 returns to step S50 and continues monitoring the operation mode of each SSD 31.

FIG. 10 is a flowchart of the SSD activation processing executed in step S20 in FIG. 9.

In step S210, the CPU 21 searches for the number of already activated SSDs 31. Under this circumstance, the CPU 21 searches for the number of the already activated SSDs 31 in the drive unit 30 by, for example, searching data stored in the memory 22 for data indicating the PWRDIS set value and the activation status of each SSD.

In step S220, the CPU 21 sets the number of simultaneous activation devices of SSDs to the drive unit 30 on the basis of the number of the activated SSDs found by the search in step S210. Under this circumstance, for example, the CPU 21 can read the setting information of the number of simultaneous activation devices as indicated in FIG. 5A from the storage unit 23 and set the number of simultaneous activation devices corresponding to the number of the already activated SSDs on the basis of the above-described setting information.

In step S230, the CPU 21: selects an SSD as an activation target from among the non-activated SSDs 31 on the basis of the number of simultaneous activation devices which was set in step S220; and outputs the PWRDIS control command to set the PWRDIS set value to “De-Assert” as an activation instruction to the relevant SSD. This control command is converted into a control signal for a specified signal pin by the bus interface 25 and is output to the relevant SSD.

In step S240, the CPU 21 executes an initialization sequence on the SSD 31 to which the activation instruction was output in step S230. As a result of this processing, the activated SSD 31 is initialized and enters into an operable state. The SSD 31 regarding which the initialization is completed notifies the CPU 21 of the completion of the initialization via the bus interface 25.

In step S250, the CPU 21 judges whether the initialization of each SSD 31, to which the activation instruction was output in step S230, has been completed or not. This judgment is performed by judging whether the initialization completion notice transmitted from each SSD exists or not. As the result of the judgment in step S250, if any SSD 31 regarding which the initialization has not been completed is included in the SSDs 31 to which the activation instruction was output, the CPU 21 executes retry processing on the relevant SSD in step S260, then return to step S240, and re-executes the initialization sequence. On the other hand, if the initialization of all the SSDs 31, to which the activation instruction was output, has been completed, the CPU 21 terminates the processing flow in FIG. 10.

With the storage apparatus 100 according to this embodiment as explained above, the CPU 21 in the controller 20 executes the SSD activation processing in FIG. 10 and thereby sets the number of simultaneous activation devices with respect to the plurality of SSDs 31 possessed by the drive unit 30 (step S220). Specifically, the CPU 21 sets the number of simultaneous activation devices based on the number of the already activated SSDs among the plurality of the SSDs 31 possessed by the drive unit 30. Then, the CPU 21 selects, as an activation target SSD(s), at least one of the non-activated SSDs 31 from among the plurality of the SSDs 31 in the quantity equal to or less than the number of simultaneous activation devices which has been set and outputs an activation instruction to each selected activation target SSD (step S230). Consequently, it is possible to suppress the electric power consumption when activating the drive unit 30 and prevent the electric power consumption from exceeding the power supply ability of the power source unit 10.

FIG. 11 is a flowchart of the power state application processing executed in step S30 in FIG. 9.

In step S310, the CPU 21 acquires the power state information from each SSD 31 possessed by the drive unit 30. Under this circumstance, the CPU 21 outputs the power state acquisition command to each already activated SSD 31 in the drive unit 30 via the bus interface 25 and acquires the power state information as illustrated in FIG. 6A from each SSD by receiving the power state information transmitted from each SSD in accordance with this command.

In step S320, the CPU 21 starts loop processing with respect to each SSD 31 whose power state information is acquired in step S310. During this loop processing, each processing of steps S331 to S342 explained below is executed for each SSD.

In step S331, the CPU 21 sets an initial value 0 to a variable i which is used to designate the power state number in the following processing.

In step S332, the CPU 21 refers to the information of the power state number according to the value of the variable i among the power state information of the relevant SSD which was acquired in step S310. Specifically, the CPU 21 refers to the parameter information of PS #i among the parameter information, as illustrated in FIG. 6B, which is set for each power state number in the power state information.

In step S333, the CPU 21 judges whether or not a support for the maximum electric power consumption exists with respect to the parameter information of PS #i which was referenced in step S332. If the information of the maximum electric power consumption is included in the parameter information of PS #i, it is determined that the support exists, and the processing proceeds to step S334; and if the information of the maximum electric power consumption is not included in the parameter information of PS #i, it is determined that the support does not exist, and the processing proceeds to step S340.

In step S334, the CPU 21 judges whether or not a support for the average electric power consumption exists with respect to the parameter information of PS #i which was referenced in step S332. If the information of the average electric power consumption is included in the parameter information of PS #i, it is determined that the support exists, and the processing proceeds to step S335; and if the information of the average electric power consumption is not included in the parameter information of PS #i, it is determined that the support does not exist, and the processing proceeds to step S336.

In step S335, the CPU 21 judges whether or not the value of the average electric power consumption for the relevant power state number indicated in the parameter information of PS #i which was referenced in step S332 is equal to or less than a specified specification value which is defined for each SSD 31. As a result, if the average electric power consumption is equal to or less than the specified specification value, the processing proceeds to step S337; and if the average electric power consumption exceeds the specified specification value, the processing proceeds to step S340.

In step S336, the CPU 21 judges whether or not the value of the maximum electric power consumption for the relevant power state number indicated in the parameter information of PS #i which was referenced in step S332 is equal to or less than a specified specification value which is defined for each SSD 31. As a result, if the maximum electric power consumption is equal to or less than the specified specification value, the processing proceeds to step S337; and if the maximum electric power consumption exceeds the specified specification value, the processing proceeds to step S340.

In step S337, the CPU 21 refers to a value of the non-operational state (NOPS) in the parameter information of PS #i, which was referenced in step S332, and if the value is “0,” that is, if the operation mode of the SSD 31 with the relevant power state number is in the operational state, the processing proceeds to step S338. On the other hand, if the value of the NOPS is “1,” that is, if the operation mode of the SSD 31 with the relevant power state number is in the non-operational state, the processing proceeds to step S340.

In step S338, the CPU 21 registers PS #i, regarding which the parameter information was referenced in step S332, as the power state number with which the relevant SSD is operable. The information of the power state number registered here is stored in the memory 22 and also stored in the storage unit 23 as necessary.

In step S339, the CPU 21 applies the power state setting according to the search result by designating the power state number setting registered in step S338 to the relevant SSD. If the processing of step S339 is terminated, the CPU 21 proceeds to step S350, completes the loop processing on the relevant SSD, and starts the loop processing on the next SSD.

In step S340, the CPU 21 judges whether or not the number of power state supports (NPSS) in the power state information of the relevant SSD, which was acquired in step S310, is equal to the value of the current variable i. If the value of the variable i matches the NPSS, the processing proceeds to step S341; and if the value of the variable i does not match the NPSS, the processing proceeds to step S342.

In step S341, the CPU 21 executes block processing on the relevant SSD. The block processing is processing for operating the drive unit 30 by excluding the relevant SSD from I/O processing targets with respect to SSDs to which the operation mode cannot be set because no operation mode which satisfies the electric power specifications exists. For example, the block processing can be executed by operating the relevant SSD in the non-operational state and blocking the power supply to the relevant SSD. When the block processing in step S341 terminates, the CPU 21 proceeds to step S350, completes the loop processing on the relevant SSD, and starts the loop processing on the next SSD.

In step S342, the CPU 21 adds 1 to the value of the variable i. After executing the processing in step S342, the CPU 21 returns to step S332 and executes processing in step S332 and subsequent steps according to the value of the variable i after the addition.

As a result of the above-explained processing in steps S332 to S342, the operation mode which satisfies the conditions of the electric power specifications and can be set is searched for sequentially with respect to each SSD 31 from the operation mode with a small power state number in ascending order, that is, from the operation mode with large electric power consumption in descending order. Then, once the operation mode which can be set is found by the search, the CPU 21 terminates the operation mode search processing on the relevant SSD and sets the operation mode found by the search. Consequently, it is designed that the operation mode with the largest possible electric power consumption under the conditions of the electric power specifications, that is, the operation mode which makes it possible to obtain the highest possible I/O processing performance, is set to each SSD.

Incidentally, after executing the processing of step S338, the CPU 21 may proceed to step S340 without proceeding to step S339. By doing so, it becomes possible to search for a plurality of operation modes which can be set to each SSD. In this case, if it is determined in step S340 that the value of the variable i matches the NPSS, it is preferable that the CPU 21 should proceed to step S339, but not to step S341, select any one of the power state numbers registered in step S338 by the processing which has been executed until then, and designate the setting of the selected power state number to the relevant SSD.

Furthermore, the judgment processing in step S340 may be performed with a judgment condition different from the above. For example, the judgment processing in step S340 may be performed by referring to the value of the maximum electric power consumption in the parameter information of PS #i, which was referenced in step S332, and judging whether this value is 0 or not. Furthermore, if it is determined that the value of the NOPS is “1” in step S337, the CPU 21 may proceed to step S341 and execute the block processing without performing the judgment in step S340.

When the execution of the loop processing on all the SSDs 31 terminates, the CPU 21 terminates the processing flow of FIG. 11.

With the storage apparatus 100 according to this embodiment as explained above, the CPU 21 in the controller 20 executes the power state application processing in FIG. 11 and thereby acquires the power state information from each of the plurality of the SSDs 31 possessed by the drive unit 30 (step S310) and sets the operation mode to the plurality of the SSDs 31 on the basis of the acquired power state information and the electric power specifications indicating the permissible electric power consumption which can be assigned to each SSD 31 (step S339). Specifically, the CPU 21 sets the operation mode of each SSD 31 so that at least either one of the condition requiring that the maximum electric power consumption indicated in the power state information is less than the electric power value defined in the electric power specifications (step S336), and the condition requiring that the average electric power consumption indicated in the power state information is equal to or less than the electric power value defined in the electric power specifications (step S335), should be satisfied. Accordingly, even if the correspondence relationship between the power state number and the electric power consumption for each operation mode varies depending on each SSD, the operation mode of each SSD can be set appropriately according to the power supply ability of the power source unit 10. Consequently, it is possible to prevent the electric power consumption from exceeding the power supply ability of the power source unit 10 during the operation of the drive unit 30.

FIG. 12 is a flowchart of the power state monitoring processing executed in step S50 in FIG. 9.

In step S510, the CPU 21 acquires current set value of the power state number of each SSD 31. Under this circumstance, the CPU 21 outputs a control command to each SSD 31 in operation in the drive unit 30 to request the current set value of the power state number via the bus interface 25. Then, the CPU 21 acquires the current set value of the power state number of each SSD by receiving the information transmitted from each SSD in response to the control command.

In step S520, the CPU 21 judges whether or not the set value of the power state number of each SSD, which was acquired in step S510, matches an expected power state number. Under this circumstance, the CPU 21 compares the acquired set value of the power state number with the power state number of each SSD which was registered and stored in the memory 22 in step S338 in FIG. 11, and judges whether they match each other or not with respect to each SSD. As a result, if the current set value of the power state number matches the registered value with respect to all the SSDs, the CPU 21 terminates the processing flow in FIG. 12. On the other hand, if the current set value of the power state number does not match the registered value with respect to at least one of the SSDs, the CPU 21 selects the relevant SSD as a processing target for subsequent processing and proceeds to step S530.

In step S530, the CPU 21 executes the initialization sequence similar to that of step S240 in FIG. 10 with respect to each SSD selected as the processing target. As a result of this processing, the current setting of the relevant SSD is cancelled and returns to the initial state. The SSD 31 regarding which the initialization has been completed notifies the CPU 21 of the completion of the initialization via the bus interface 25.

In step S540, the CPU 21 judges whether or not the initialization of the SSD 31 selected as the processing target has been completed or not. This judgment is performed by determining whether the initialization completion notice transmitted from the relevant SSD exists or not. As a result of the judgment in step S540, if any SSD 31 regarding which the initialization has not been completed is included in the SSDs selected as the processing targets, the CPU 21 executes the retry processing on the relevant SSD in step S550, then returns to step S530, and executes the initialization sequence again. On the other hand, if the initiation of all the SSDs 31 selected as the processing targets has been completed, the processing proceeds to step S560.

In step S560, the CPU 21 applies the power state setting according to the search result of the power state application processing executed upon activation by designating the setting of the registered power state number to the relevant SSD. After finishing the processing in step S560, the CPU 21 terminates the processing flow in FIG. 12.

With the storage apparatus 100 according to this embodiment as explained above, the CPU 21 in the controller 20 regularly acquires the operation mode setting status during the operation of each SSD 31 by executing the power state monitoring processing in FIG. 12 (step S510). Then, if the acquired operation mode setting status does not match the operation mode found by the operation mode search processing executed in steps S332 to S342 in FIG. 11 (step S520: No), the CPU 21 resets the operation mode (step S560). Consequently, even if any erroneous setting of the operation mode occurs in any one of the SSDs 31 in the drive unit 30, it is possible to prevent the electric power consumption of the entire storage apparatus 100 from exceeding the power supply ability of the power source unit 10.

According to an embodiment of the present invention explained above, the following operations and effects are obtained.

(1) The storage apparatus 100 comprises a plurality of SSDs 31 that read and write data by operating in any one of a plurality of operation modes which vary in electric power consumption, and the controller 20 that controls the SSDs 31. Each of the plurality of SSDs 31 retains power state information indicating electric power consumption of each of the operation modes. The controller 20 acquires the power state information from each of the plurality of SSDs 31 (step S310), and sets the operation modes for the plurality of SSDs 31 on the basis of the acquired power state information and permissible electric power consumption which can be assigned to each of the SSDs 31 (steps S332 to S342). As a result, Because of this, appropriate electric power control for the storage apparatus 100 can be realized.

(2) The power state information includes, for example, as shown in FIGS. 6A and 6B, at least any one of information of maximum electric power consumption and average electric power consumption in each of the operation modes of the SSDs 31. In addition, the permissible electric power consumption of each SSD 31 includes permissible maximum electric power consumption indicating maximum electric power consumption which can be assigned to each of the SSDs 31, and permissible average electric power consumption indicating average electric power consumption which can be assigned to each of the SSDs 31. The controller 20 sets the operation mode of each of the SSDs 31 to satisfy at least either one of a first condition requiring that the maximum electric power consumption be less than the permissible maximum electric power consumption (step S336), and a second condition requiring that the average electric power consumption be equal to or less than the permissible average electric power consumption (step S335). Specifically, the controller 20 sets, to each of the SSDs 31, either one of: an operation mode in which the power state information includes information of the maximum electric power consumption (MP, MXPS), but does not include information of the average electric power consumption (ACTP, APS), and which satisfies the first condition; and an operation mode in which the power state information includes the information of the maximum electric power consumption and the average electric power consumption (MP, MXPS, ACTP, APS), and which satisfies the second condition (steps S338, S339). Because of this, an appropriate operation mode corresponding to its electric power consumption can be set to each SSD 31 and thereby electric power control can be performed to each SSD 31.

(3) The controller 20 executes operation mode search processing for searching for the operation mode which can be set to each of the plurality of SSDs 31 on the basis of the power state information acquired from each of the plurality of SSDs 31 (steps S332 to S342). In steps S338 and S339, the controller 20 sets the operation mode, which is found by the operation mode search processing, to each of the SSDs 31. Because of this, an appropriate operation mode corresponding to its electric power consumption can surely be set to each SSD 31.

(4) The controller 20 executes the operation mode search processing of steps S332 to S342 on each of the SSDs 31 by judging whether the operation mode can be set or not, with respect to the operation modes in descending order of the electric power consumption. As a result, if it is determined that the operation mode can be set (step S335: Yes or step S336: Yes), the controller 20 terminates the operation mode search processing on the relevant SSD 31. Because of this, the operation mode of the highest electric power consumption, accordingly which makes it possible to obtain the highest I/O processing performance, can be found as a settable operation mode among the operation modes which satisfy the electric power specification.

(5) The controller 20 regularly acquires a setting status of the operation mode while each of the SSDs 31 is in operation (step S510). And, if the acquired setting status of the operation mode does not match the operation mode which has been found by the operation mode search processing (step S520: No), the controller 20 resets the operation mode (step S560). Because of this, even if any erroneous setting of the operation mode occurs in any one of the SSDs 31, it is possible to prevent the electric power consumption of the storage apparatus 100 from exceeding the power supply ability of the power source unit 10.

(6) When electric power is supplied to the storage apparatus 100, the controller 20 sets the number of simultaneous activation devices to the plurality of SSDs 31 (step S220). And the controller 20 selects, as activation target SSD, at least any one of SSDs which have not been activated from among the plurality of SSDs 31 in a quantity equal to or less than the number of simultaneous activation devices which has been set, and outputs an activation instruction to each of the selected activation target SSDs (step S230). Because of this, it is possible to suppress the electric power consumption of the entire drive unit 30 including a plurality of SSDs 31 when activating it, and thereby prevent the electric power consumption from exceeding the power supply ability.

(7) The controller 20 sets the number of simultaneous activation devices on the basis of the number of already activated SSDs among the plurality of SSDs 31 (steps S210, S220). Because of this, it is possible to set the number of simultaneous activation devices appropriately in consideration of electric power consumption by the already activated SSDs.

(8) After executing the power state application processing in step S30, the controller 20 returns to the SSD activation processing of step S20 (step S40: Yes). By doing this, the controller 20 performs, after completing to set the operation mode to all the activation target SSDs in steps S338 and S339, which was selected in the previous step S230, next selection of the activation target SSDs in step S230. Because of this, it is possible to sequentially activate each of the SSDs 31 in the quantity equal to or less than the number of simultaneous activation devices.

Incidentally, the present invention is not limited to the embodiments describe above and can be implemented by using arbitrary constituent elements within the scope not departing from the gist of the invention. For example, the configuration of the redundant system may be omitted by providing one power source unit 10 and one controller 20, respectively. Moreover, the processing of this embodiment may be implemented by having the controller 20 include a plurality of CPUs 21 and causing the plurality of CPUs 21 to operate in cooperation with each other. Furthermore, a part or the whole of the processing of this embodiment may be implemented by hardware such as an FPGA (Field-Programmable Gate Array).

The embodiments and variations explained above are merely examples and the present invention is not limited to the details of such embodiments and variations unless the features of the invention are impaired. Furthermore, the various embodiments and variations are explained above, but the present invention is not limited to the details of such embodiments and variations. Other aspects which can be thought of within the scope of the technical idea of the present invention are also included within the scope of the present invention.

### REFERENCE SIGNS LIST

10: power source unit
20: controller
21: CPU
22: memory
23: storage unit
24: channel adapter
25: bus interface
30: drive unit
31: SSD
100: storage apparatus

What is claimed is:

1. A storage apparatus comprising:
a plurality of storage devices that read and write data by operating in any one of a plurality of operation modes which vary in electric power consumption; and
a control unit that controls the storage devices,
wherein each of the plurality of storage devices retains power state information indicating electric power consumption of each of the operation modes; and
wherein the control unit acquires the power state information from each of the plurality of storage devices and sets the operation modes for the plurality of storage devices on the basis of the acquired power state information and permissible electric power consumption which can be assigned to each of the storage devices.

2. The storage apparatus according to claim 1,
wherein the power state information includes at least any one of information of maximum electric power consumption and average electric power consumption in each of the operation modes of the storage devices;
wherein the permissible electric power consumption includes permissible maximum electric power consumption indicating maximum electric power consumption which can be assigned to each of the storage devices, and permissible average electric power consumption indicating average electric power consumption which can be assigned to each of the storage devices; and
wherein the control unit sets the operation mode of each of the storage devices to satisfy at least either one of a first condition requiring that the maximum electric power consumption be less than the permissible maximum electric power consumption, and a second condition requiring that the average electric power consumption be equal to or less than the permissible average electric power consumption.

3. The storage apparatus according to claim 2,
wherein the control unit sets, to each of the storage devices, either one of:
an operation mode in which the power state information includes information of the maximum electric power consumption, but does not include information of the average electric power consumption, and which satisfies the first condition; and
an operation mode in which the power state information includes the information of the maximum electric power consumption and the average electric power consumption, and which satisfies the second condition.

4. The storage apparatus according to claim 1,
wherein the control unit:
executes operation mode search processing for searching for the operation mode which can be set to each of the plurality of storage devices on the basis of the power state information acquired from each of the plurality of storage devices; and
sets the operation mode, which is found by the operation mode search processing, to each of the storage devices.

5. The storage apparatus according to claim 4,
wherein the control unit:
executes the operation mode search processing on each of the storage devices by judging whether the operation mode can be set or not, with respect to the operation modes in descending order of the electric power consumption; and
terminates the operation mode search processing on each of the storage devices if it is determined that the operation mode can be set.

6. The storage apparatus according to claim 4,
wherein the control unit:
regularly acquires a setting status of the operation mode while each of the storage devices is in operation; and
resets the operation mode if the acquired setting status of the operation mode does not match the operation mode which has been found by the operation mode search processing.

7. The storage apparatus according to claim 1,
wherein when electric power is supplied to the storage apparatus, the control unit:
sets the number of simultaneous activation devices to the plurality of storage devices;
selects, as activation target storage devices, at least any one of storage devices which have not been activated from among the plurality of storage devices in a quantity equal to or less than the number of simultaneous activation devices; and
outputs an activation instruction to each of the selected activation target storage devices.

8. The storage apparatus according to claim 7,
wherein the control unit sets the number of simultaneous activation devices on the basis of the number of already activated storage devices among the plurality of storage devices.

9. The storage apparatus according to claim 7,
wherein after completing to set the operation mode to all the selected activation target storage devices, the control unit performs next selection of the activation target storage device.

10. A method for controlling a storage apparatus equipped with a plurality of storage devices that read and write data by operating in any one of a plurality of operation modes which vary in electric power consumption, comprising:
acquiring power state information indicating electric power consumption of each of the operation modes from each of the plurality of storage devices; and
setting the operation modes for the plurality of storage devices on the basis of the acquired power state information and permissible electric power consumption which can be assigned to each of the storage devices.
